(19) United States
(12) Patent Application Publication
(10) Pub. No.: US 2006/0096468 A1
(43) Pub. Date: May 11, 2006

(54) Gas dispensing device

(76) Inventor: Alan Paine, San Dimas, CA (US)

Correspondence Address: James E. Brunton, Esquire, Post Office Box 29000, Glendale, CA, 91209-9000, US

(21) Appl. No.: 10/985,771

(22) Filed: Nov. 9, 2004

(51) Int. Cl. A47J 27/04

(52) U.S. Cl. 99/473

(57) ABSTRACT

The present invention provides a novel gas dispensing device that can be conveniently inserted into a closed container, such as a food container, or a storage container, and can then be ruptured by forces exerted on the gas dispensing device from outside the container so as to controllably fill the closed container with the inert gases contained within the reservoir of the gas dispensing device.

### BACKGROUND OF THE INVENTION

1. Field of the Invention

The present invention relates generally to dispensing devices for dispensing gases into closed containers. More particularly, the invention concerns a gas dispensing device for dispensing an inert gas into a closed container, such as a plastic food storage bag, within which the dispensing device is disposed. In one form of the invention, the device includes a generally tubular shaped, yieldably deformable plastic body portion having a chamber for containing the gas to be dispensed. The chamber has a frangible wall that is rupturable by forces exerted on said device from outside the closed container.

2. Discussion of the Prior Art

It has long been recognized that by packaging certain types of products, such as foodstuffs and the like in an inert atmosphere, undesirable deterioration of the product can be slowed and an increase in its shelf life can be realized.

By way of example, U.S. Pat. No. 4,762,722 issued to Izumimoto discloses a package construction for packaging fresh meat, wherein the atmosphere to which the meat is exposed is controlled so as to permit the meat to remain fresh and to continue to exhibit a natural red color.

In a somewhat similar vein, the patent to Hirsch et al., discloses a package for controlling the atmosphere of a packaged product. The Hirsch et al., package includes first and second walls sealed at their peripheries to define a product cavity therebetween. One package wall is formed from a gas permeable material and a second package wall includes a composite of an inner, gas permeable material and an outer, gas impermeable layer. The outer layer is movable away from the inner layer to allow gases to flow through the inner layer to thereby change the atmospheric condition of the packaged product.

A common drawback of the prior art, atmosphere controlled packaging is its complexity of construction and often its undue difficulty of operation. The gas dispensing means of the present invention seeks to overcome these drawbacks by providing a device that is of simple construction, is easy to use and is highly versatile in application.

By way of brief summary, one form of the gas dispensing device of the present invention for dispensing an inert gas into a closed food container within which the device is disposed, comprises a yieldably deformable, generally tubular-shaped plastic body portion, which includes a sealed chamber for containing the inert gas to be dispensed. The body portion has first and second closed ends and a frangible wall disposed amid the closed ends. The frangible wall is easily ruptured by the exertion of twisting forces on the body portion from outside the closed container. Upon rupturing the frangible wall, the inert gas under pressure contained within the sealed chamber will controllably flow into the food container thereby changing the atmosphere within the container.

### SUMMARY OF THE INVENTION

It is an object of the present invention to provide a novel gas dispensing device that can be conveniently inserted into a closed container, such as a food container, or a storage container, and can then be ruptured by forces exerted on the gas dispensing device from outside the container so as to controllably fill the closed container with the inert gases contained within the reservoir of the gas dispensing device.

It is another object of the invention to provide a gas dispensing device of the aforementioned character that is of the simple construction, is versatile in application and can be safely and easily used.

A particular object of the invention is to provide a gas dispensing device of the type described in the preceding paragraph that can be conveniently inserted into sealable plastic containers, such as food storage bags, and can be used to control the atmosphere within the food storage bag so as to slow the deterioration of the food contained within the bag.

Another object of the invention is to provide a gas dispensing device of the character described that can be inexpensively manufactured in large quantity.

### BRIEF DESCRIPTION OF THE DRAWINGS

FIG. 1 is a generally perspective view of one form of the gas dispensing device of the present invention.

FIG. 2 is an enlarged side view of one of the crimped end portions of the device illustrated in FIG. 1.

FIG. 3 is an enlarged, cross-sectional view taken along lines 3-3 of FIG. 1.

FIG. 4 is a generally perspective view showing the gas dispensing device of the invention disposed within a storage bag, such is a food storage bag, that is to be pressurized with the gas contained within the reservoir of the gas dispensing device.

FIG. 5 is a generally perspective view, similar to FIG. 4, but showing the appearance of the storage bag after it has been filled with the gas contained within the reservoir of the gas dispensing device.

### DESCRIPTION OF THE INVENTION

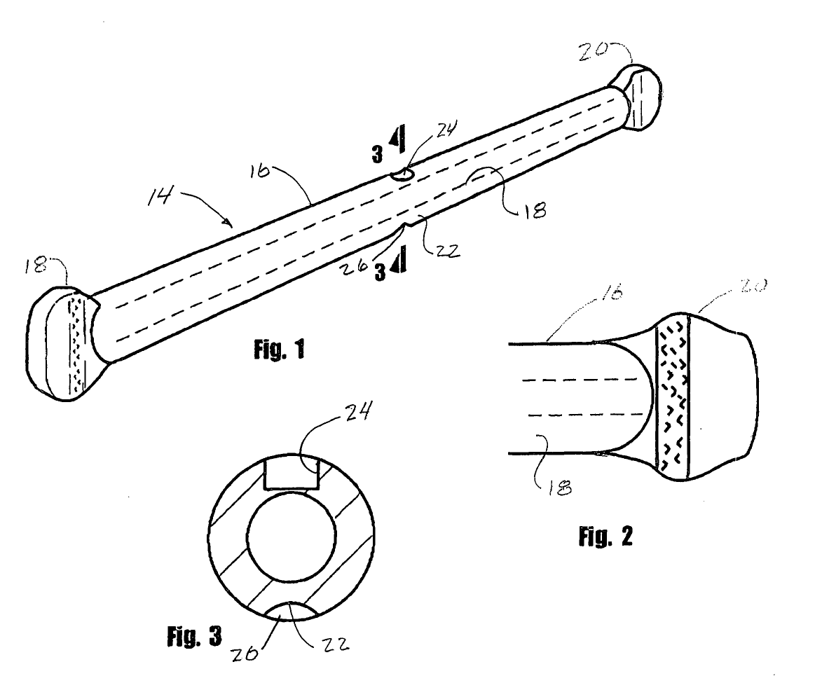

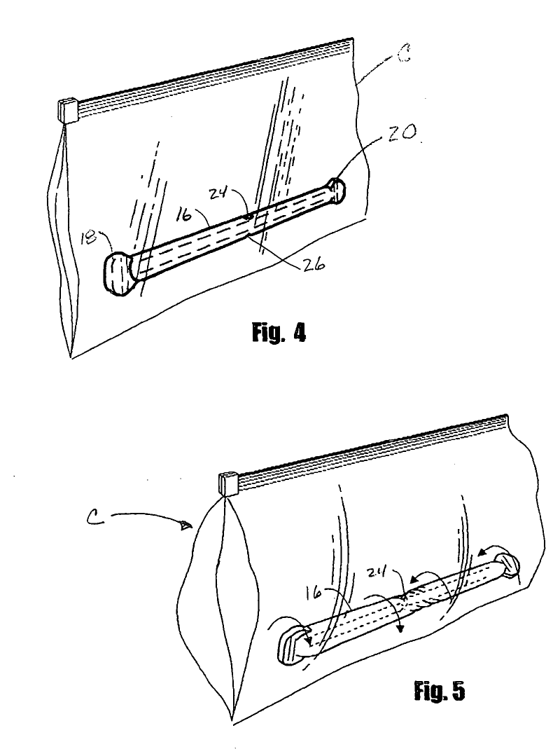

Referring to the drawings and particularly to FIGS. 1, 2 and 3, one form of the gas dispensing device of the present invention is there illustrated and generally designated by 14. Device 14 here includes a yieldably deformable, generally tubular-shaped plastic body portion 16 having a chamber, or reservoir 18 for containing the inert gas to be dispensed into the container, such as the plastic, ziplock container “C” within which the device is placed (see FIG. 4). As best seen in FIG. 1, body portion 16 has first and second ends 18 and 20 that are sealably closed by crimping the end portions of the body 16 by a conventional method in the manner shown in FIGS. 1 and 2. Device 14 can be constructed from a number of plastic materials, such as polyethylene or the like.

An important feature of the device of the present invention is the provision of a yieldably deformable, frangible plastic wall 22 that is disposed intermediate said first and second closed ends 18 and 20 (see FIGS. 1 and 3). As illustrated in FIGS. 1 and 3, frangible wall 22 is provided with a counterbore 24 and an oppositely disposed notch or cleave 26. With this construction, either a bending, or twisting force (see the arrows in FIG. 5) exerted on the body portion 16 from the exterior of container “C” will cause frangible wall 22 to rupture in the area of the counterbore 24 and the cleave 26, thereby permitting the gases contained within chamber 18 to flow into the interior of the storage container to pressurize the container as illustrated in FIG. 5 of the drawings. Uniquely, the forces necessary to rupture the frangible wall 22 can be exerted on the device from outside the container so that the container need not be opened to accomplish the container pressurization step.

While a number of different gases can be contained within the gas reservoir of the device, inert gases such as nitrogen and carbon dioxide are most frequently used to provide the desired atmosphere within the storage container “C”.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A gas dispensing device for dispensing gas into a closed container within which the device is disposed, said device having a chamber for containing the gas to be dispensed, said chamber having a frangible wall rupturable by forces exerted on said device from outside the closed container.

2. The device as defined in claim 1 in which said chamber is formed by a yieldably deformable plastic wall, said wall having a counterbore formed therein.

3. The device as defined in claim 2 in which said yieldably deformable plastic wall is generally cylindrical in shape and further includes a cleave formed in said wall at a spaced-apart location from said counterbore.

4. The device as defined in claim 3 in which said frangible wall is rupturable by a bending force exerted on said yieldably deformable plastic wall.

5. The device as defined in claim 3 in which said frangible wall is rupturable by a twisting force exerted on said yieldably deformable plastic wall.

6. The device as defined in claim 3 in which said gas contained within said chamber comprises an inert food preserving gas.

7. The device as defined in claim 6 in which said inert gas comprises nitrogen.

8. The device as defined in claim 6 in which said inert gas comprises carbon dioxide.

9. The device as defined in claim 6 in which said inert gas comprises a blend of inert gases.

10. A gas dispensing device for dispensing an inert gas into a closed food container within which the device is disposed, said device having a yieldably deformable, generally tubular-shaped body portion having a chamber for containing the inert gas to be dispensed, said body portion having first and second closed ends and a frangible wall disposed intermediate said first and second closed ends, said frangible wall being rupturable by forces exerted on said device from outside the closed container to discharge said inert gas into the container so as to reduce the oxygen content therein to therby slow spoilage.

11. The device as defined in claim 10 in which said frangible wall is provided with a counterbore and an oppositely disposed cleave.

12. The device as defined in claim 10 in which said food container comprises a plastic food storage bag.

13. The device as defined in claim 10 in which said frangible wall is rupturable by a twisting force exerted on said body portion.

14. The device as defined in claim 10 in which said tubular-shaped body portion is formed from a plastic material.

15. The device as defined in claim 10 in which said inert gas comprises a blend of carbon dioxide and nitrogen.

16. A gas dispensing device for dispensing an inert gas into a closed plastic food storage bag within which the device is disposed, said device having a yieldably deformable, generally tubular-shaped body portion having a chamber for containing the inert gas to be dispensed, said body portion having first and second closed ends and a frangible wall disposed intermediate said first and second closed ends, said frangible wall being provided with a counterbore and being rupturable by forces exerted on said device from outside the closed container.

17. The device as defined in claim 16 in which said frangible wall further includes a cleave diametrically opposed from said counterbore.

18. The device as defined in claim 16 in which said frangible wall is rupturable by a twisting force exerted on said body portion.

19. The device as defined in claim 16 in which said inert gas comprises nitrogen.

20. The device as defined in claim 16 in which said inert gas comprises carbon dioxide.
